(19) United States
(12) Patent Application Publication
(10) Pub. No.: US 2010/0293573 A1
(43) Pub. Date: Nov. 18, 2010

(54) APPARATUS AND METHOD FOR SEARCHING BROADCASTING CHANNEL

(75) Inventors: Min Goo Kang, Gumi-si (KR); Seong Guen Song, Gumi-si (KR)

Correspondence Address: KED & ASSOCIATES, LLP, P.O. Box 221200, Chantilly, VA, 20153-1200, US

(73) Assignee: LG Electronics Inc., Seoul (KR)

(21) Appl. No.: 12/809,924

(22) PCT Filed: Nov. 25, 2008
(86) PCT No.: PCT/KR2008/006941

§ 371 Date: Jun. 21, 2010

(30) Foreign Application Priority Data
Dec. 24, 2007 (KR) 10-2007-0136382

(51) Int. Cl. H04N 5/445

(52) U.S. Cl. 725/39

(57) ABSTRACT

The present invention relates to an apparatus of searching a broadcast channel and a method of the same. According to the present invention, a quick channel searching is achieved because information of two channels may be searched simultaneously on at least two divided sections of a screen with a single channel change input signal. Furthermore, it is possible to compare and select channels because one of the channels is fixed and only the other one is changeable on the at least two divided sections of the screen.

### TECHNICAL FIELD

The present invention relates to a broadcast receiver. More specifically, the present invention relates to an apparatus of searching a broadcast channel for a digital television and a method of the same.

### BACKGROUND ART

Digital televisions or digital video recorders (hereinafter, DVR) typically have a function of searching broadcast images received via various channels. Such the channel searching function is performed automatically and a synchronization-detected one of the channels is selected sequentially and an image of the selected channel is displayed in order. That is, a signal of receiving broadcast channels which are tuned at by the digital TV is displayed at an overall screen or predetermined portion of a screen. Such a conventional channel searching apparatus uses a single tuner to receive a broadcasting signal and it receives analog and digital broadcasting signals according to a user's selection independently. Or, the conventional channel searching apparatus uses plural tuners to receive the analog and digital broadcasting signals separately or simultaneously.

The conventional digital broadcasting receiver uses a single tuner for both analog/digital signals or two tuners, including a tuner for an analog signal and a tuner for both analog and digital signals, only to receive analog and digital broadcasting signals.

Entire channels are searched one time to form a channel map. If then, the user operates a remote control and searches channels stored in the channel map to search a favorite program.

### DISCLOSURE OF INVENTION

### Technical Problem

However, the user selects channels based on his/her various tastes. As a result, it is difficult for the user to recognize contents of the selected program only with the number or title of the channel and it takes quite a time to search channels.

Moreover, an image for a single channel is moved according to a single remote control input signal to provide the user with channel information. As a result, the user has to input button signals too many times to search plural channels stored in the channel map, which is inconvenient.

### Technical Solution

To achieve objects and advantages and in accordance with the purpose of the invention, as embodied and broadly described herein, an apparatus of searching a channel for a broadcast receiver includes an IR receiving part for receiving a channel searching request signal and a channel change signal; a memory for storing a channel map to which channels are registered; first and second tuners for receiving at least two different channels, respectively, according to the channel searching request; a control part for controlling broadcasting programs of the channels received by the first and second tuners to be displayed on at least two divided sections of a screen, the control part controlling the channels displayed on the divided sections of the screen to be simultaneously changed into former or next ones in an order of a channel number registered to the channel map, respectively; and a display part for displaying the broadcasting programs of the channels via the at least two divided sections of the screen, respectively, according to the channel searching request.

The control part may control the channel displayed on the other section of the screen to be changed in an order of a channel number registered to the channel map based on a fixed channel, if a signal is inputted to fix one of the channels displayed on the at least two divided sections of the screen.

The control part may mute an audio signal of the broadcasting program received from one of the channels displayed on the at least two divided sections of the screen, which is an object of a channel searching according to the channel change signal.

The control part may output an audio signal of a broadcasting program received from a selected channel if a channel selection signal is inputted for the broadcasting program received from the single fixed channel displayed on one of the divided sections of the screen.

The first tuner may receive a basic channel and the basic channel may be one of a channel viewed at the present, a channel registered to the channel map stored in the memory for the first time and a channel selected according to a number key input.

The first and second tuners may receive 2N−1 channel 2N channel which are changeable according to a number key input.

The memory may store the channel map formed based on one of a user favorite channel, a channel number, a channel genre and a list of channels viewed before.

One of selection, editing and renewal of information of the channels registered to the channel map stored in the memory may be performed on an OSD menu.

The control part may set the broadcasting programs received from the channels displayed on the at least two sections of the screen to be recordable.

In another aspect, a method of searching a channel for a broadcast receiver includes receiving a channel searching request; displaying broadcasting programs received from at least two different channels on at least two divided sections of a screen, respectively, according to the channel searching request; detecting a channel change signal, in a state of displaying the channels on the divided sections of the screen, and simultaneously changing the channels into different channels in an order of a channel number registered to a channel map based on the at least two channels according to the detected channel change signal; and displaying a broadcasting program of a selected channel on an entire section of the screen if a channel selection signal is inputted on the divided screen.

An audio signal of broadcasting programs received from the two different channels according to the channel searching request may be muted.

An audio signal of the selected broadcasting program may be outputted if the channel selection signal is inputted.

A basis channel of the at least two different ones may be one of a channel viewed at the present, a channel registered to the channel map for the first time and a channel selected according to a number key input.

The channels displayed on the at least two divided sections of the screen may be changeable according to a key input corresponding to a channel number.

Broadcasting programs of the channels displayed on the at least two divided sections of the screen may be recordable.

A quick channel searching mode may be set according to the channel searching request.

The number of either of the two different channels may be 2N−1 and the number of the other may be 2N.

The channel map may be formed based on one of a user's favorite channel, a channel number, a channel genre and a list of channels viewed before.

The method may further include performing one of selection, edition and renewal of information on the registered channels of the channel map on an OSD menu.

In a still further aspect, a method of searching a channel for a broadcast receiver includes receiving a channel searching request; displaying broadcasting programs received from at least two different channels on at least two divided sections of a screen, respectively, according to the channel searching request; fixing the broadcasting program received from the one of the channels displayed on the divided sections of the screen; detecting a channel change signal in the state of the broadcasting program being fixed; changing the channel displayed on the other section in an order of channel numbers registered to a channel map based on the fixed channel number according to the detected channel change signal; and displaying a broadcasting program of a selected channel on an entire section of the screen if a channel selection signal is inputted on the divided screen.

An audio signal of the broadcasting program received from the fixed single channel may be outputted.

The basic one of the at least two different channels may be one of a channel viewed at the present, a channel registered to the channel map for the first time and a channel selected according to a number key input.

The channel displayed on each of the at least two divided sections of the screen may be changeable according to a corresponding number key input.

The broadcasting program of the channel displayed on each of the divided sections of the screen may be recordable.

The channel displayed on the other section may be a channel which is the former one or the next one of the fixed channel.

The channel map may be formed based on one of a user favorite channel, a channel number, a channel genre and a list of channels viewed before.

The method may further include performing one of selection, editing and renewal of information on channels registered to the channel map on an OSD menu.

### ADVANTAGEOUS EFFECTS

The present invention has following advantageous effects.

According to the present invention, a user can search two broadcasting programs simultaneously only with a single button input, because two channels registered to a channel map are tuned in order and displayed via at least two divided sections of a screen.

Furthermore, user satisfaction may be maximized because the information of programs received from the two channels displayed on the divided sections of the screen is compared and selected.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a block view schematically illustrating an apparatus for searching a broadcast channel provided in a digital broadcast receiver according to an exemplary embodiment;

FIG. 2 is a flow chart illustrating a method of searching a broadcast channel for a digital broadcast receiver according an exemplary embodiment;

FIGS. 3a to 3c are diagrams of embodied screens to illustrate a broadcast channel searching process for the digital broadcast receiver according to the embodiment of FIG. 2;

FIG. 4 is a flow chart illustrating a method of searching a broadcast channel for a digital broadcast receiver according to another embodiment; and

FIGS. 5a to 5c are diagrams of embodied screens to illustrate a broadcast channel searching method of the digital broadcast receiver according to the embodiment of FIG. 4.

### BEST MODE

Reference will now be made in detail to the specific embodiments of the present invention, examples of which are illustrated in the accompanying drawings. Wherever possible, the same reference numbers will be used throughout the drawings to refer to the same or like parts.

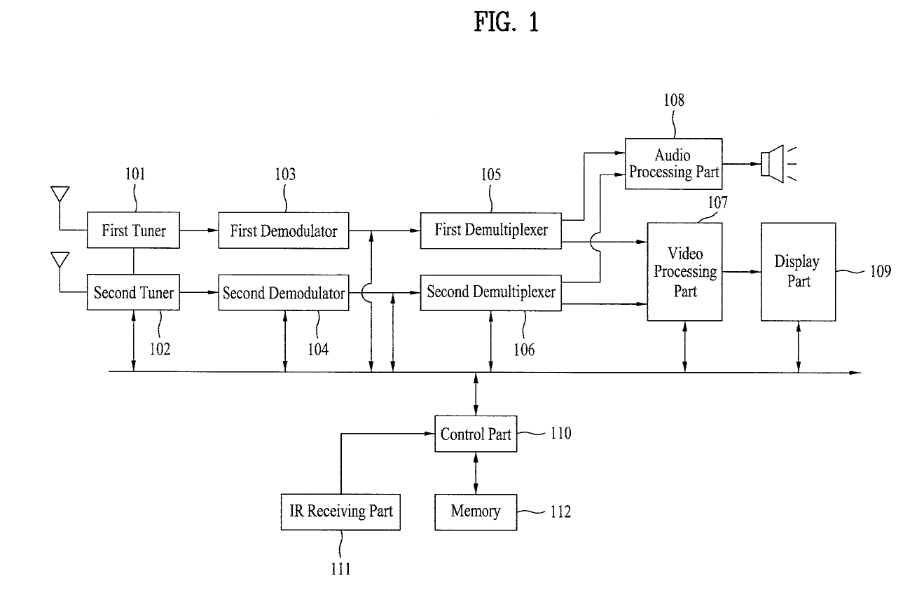

FIG. 1 is a block view schematically illustrating an apparatus of searching a broadcast channel provided in a digital broadcast receiver according to an exemplary embodiment.

As shown in FIG. 1, an apparatus of searching a channel provided in a digital broadcast receiver according to the exemplary embodiment includes a first tuner 101, a second tuner 102, a first demodulator 103, a second demodulator 104, a first demultiplexer 105, a second demultiplexer 106, an audio processing part 107, a video processing part 108, a display part 109, a control part 110, an IR receiving part 111 and a memory 112.

The first and second tuners 101 and 102 receive broadcasting programs of channels selected according to a channel searching mode, respectively. If a broadcasting program of N channel is received by the first tuner 101, a broadcasting program of N+1 channel is received by the second tuner 102 such that the broadcast channels received by the first and second tuners 101 and 102 may not be overlapped. The first and second demodulators 103 and 104 demodulate and output broadcasting signals of the channels received by the first and second tuners 101 and 102, respectively.

The first and second demultiplexers 105 and 106 separate and output a video, audio and data signal from the broadcasting signals of the channel which are demodulated by the first and second demodulators 103 and 104, respectively.

The video processing part 108 decodes the video signals outputted from the first and second demodulators 103 and 104 and it outputs the broadcasting program of the channel selected by a user via the display part 109.

The audio processing part 107 decodes and outputs the audio signal provided with the selected one of the channels displayed on a screen divided into at least two sections according to the channel searching mode.

The IR receiving part 111 receives various key input signals, channel searching request signals and channel change signals from the user.

The memory 112 stores a channel map and the channels received by the first and second tuners 101 and 102 according to an automatic channel searching function provided in the present invention may be stored in the channel map. At this time, the channel searching is automatically performed in the first and second tuner 101 and 102 based on the channel map. The channel map is formed based on one of a user's favorite channel, a channel number, a channel for each genre and a former selected channel.

The control part 110 for overall control of the broadcast receiver controls the broadcast programs of the channels, received by the first and second tuners 101 and 102, to be displayed on the at least two divided sections of the screen. If a channel change signal is inputted, images of the channel displayed in the divided sections are controlled to be changed into images of the next or former channel simultaneously.

Here, if a channel searching request signal is received from the user via the IR receiving part 111, the control part 111 sets a quick channel searching mode and divides the screen of the display part 109 into at least two sections to display the information of two channels received by the first and second tuners 101 and 102.

If the channel change signal is inputted by the user in a state of the two channels being displayed on the divided sections of the screen, the control part 110 controls the two channels to be moved to next or former ones simultaneously. Here, the order of the next or former channels is the order of the channel number stored in the channel map based on the channel received at the present. The numbers of channels stored in the channel map are separated into 2N−1 channel and 2N channel to be stored in the first and second tuners 101 and 102. When the user selecting the channel, the channels assigned to the first and second tuners 101 and 102 may not overlapped.

In case of a quick channel searching mode, the control part 110 ignores the channel received at the present and it changes the channel into channels stored in the channel map in an order of the registration, for example, changing the channel sequentially from the channel number registered to the channel map for the first time.

When changing the channels according to the quick channel searching mode, the control part 110 mutes audio signals of broadcasting programs of the two channels.

If the user inputs a request signal of fixing either of the two channels provided on the screen, the control part 110 continuously receives the broadcasting program of the fixed channel to provide it on the screen and the control part 110 displays information of a channel corresponding to a channel change signal on the other section of the screen.

At this time, the control part 110 outputs the audio of the broadcasting signal received from the fixed channel and it may change the fixed channel into a channel corresponding to a number key directly inputted by the user.

In addition, if it identifies an input signal of selecting a channel which the user wishes to watch during the channel searching on the two divided sections of the screen, the control part 110 provides a broadcasting program of the selected channel on an entire section of the screen and outputs an audio signal of the selected channel.

The control part 110 sets the broadcasting programs of the channels displayed on the divided sections of the screen to be recordable according to a user's request.

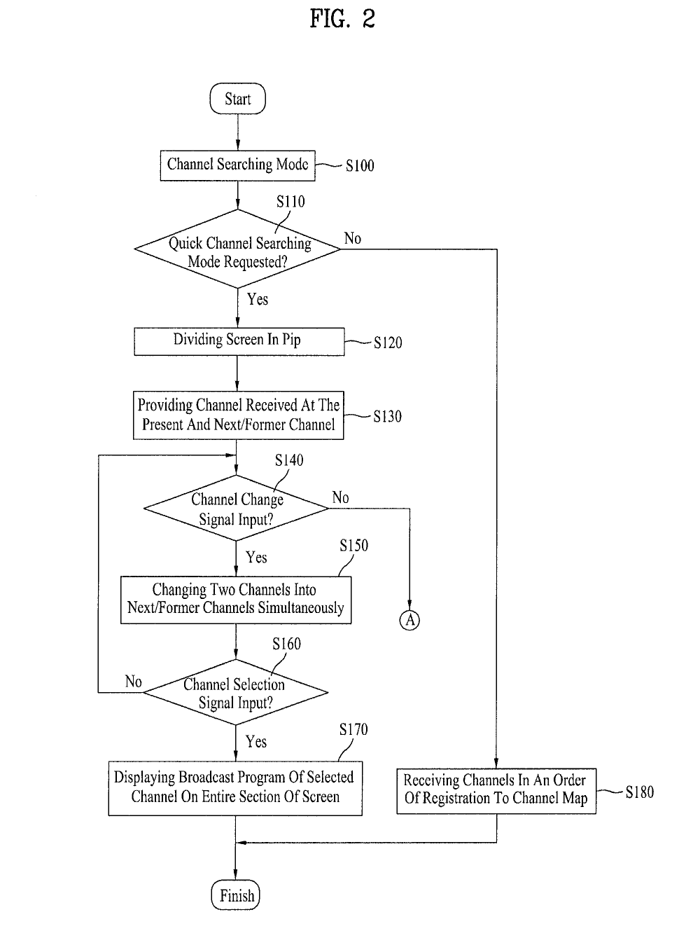

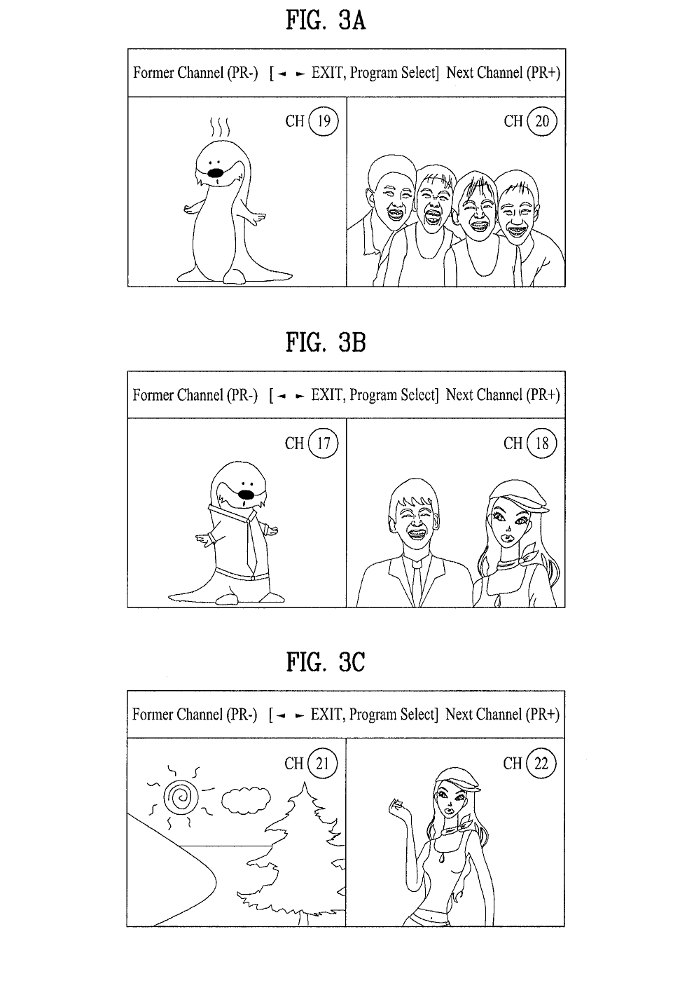

A method of searching a broadcast channel according to an exemplary embodiment in the channel searching apparatus having the above configuration will be described in reference to FIGS. 2 and 3.

FIG. 2 is a flow chart illustrating the method of searching a broadcast channel according to an exemplary embodiment and FIG. 3 is a diagram illustrating a screen of a broadcast channel searching process in a digital broadcast receiver including the broadcast channel searching apparatus.

As shown in FIG. 2, the method of searching a broadcast channel according to the exemplary embodiment includes receiving a channel searching request signal by using the IR receiving part 111 (S100) and setting a quick channel searching mode by using the control part 110 if the received channel searching signal is corresponding to a quick channel searching function (S110). Here, the channel searching request signal is sent by a user via a remote control.

In case of the quick channel searching mode, the control part 10 controls a screen of the display part 109 to be divided into at least two sections (S120).

Hence, the first and second tuners 101 and 102 receive a program of 2N−1 channel broadcasted at the present and a program of 2N channel which is the next one of 2N−1 channel, respectively. The program of 2N−1 channel is displayed at one of the at least two divided sections and the program of 2N channel is displayed at the other section of the screen at the same time (S130).

At this time, 2N−1 channel received at the present is the channel having been viewed by the user before the quick channel searching mode is inputted, the channel number registered to the channel map for the first time or one of the channels corresponding to the channel number the user inputted. The channel map is formed based on one of the user's favorite channel, the channel number, the list of channels having been viewed before.

2N channel, the next one of 2N−1 channel viewed at the present, which is provided on the screen together with 2N−1 channel, is the one registered to the channel map next to the 2N−1 channel.

When searching the information on the two channels displayed in the divided sections of the screen, each of the audio signals is muted. In the state of the two channels being displayed on the screen simultaneously, the IR receiving part 109 identifies whether a channel change signal is inputted by the user (S140).

On the result of the identification, if the channel change signal is inputted by the user, the control part 110 changes the channels of the screen into the next ones or different ones corresponding to a key button inputted to move a channel simultaneously (S150).

This process will be described more specifically in reference to FIGS. 3a to 3c.

As shown in FIG. 3a, if the quick channel searching mode is set in the broadcast receiver, a broadcasting program of ‘19 channel’ viewed at the present is received by the first tuner 101 and the program is displayed on one of the divided sections of the screen, and a broadcasting program of ‘20 channel’ registered to the channel map stored in the memory 112 next to ‘19 channel’ is received by the second tuner 102 and the program is displayed on the other divided section of the screen.

Hence, as shown in FIG. 3b, if a channel change signal as a key signal to move a channel to a former channel (PR−) is inputted by the user, the control part 110 receives and displays broadcasting programs of ‘17 channel’ and ‘18 channel’ which are former channels of ‘19 channel’ and ‘20 channel’ provided in the divided sections of the screen.

As shown in FIG. 3c, if a channel change signal as a key signal to move to a next channel (PR+) is inputted by the user, the control part 110 receives and displays broadcasting programs of ‘21 channel’ and ‘22 channel’ which are next ones of ‘19 channel’ and ‘20 channel’.

That is, corresponding to the key input, the channels are changed into next or former channels in the order of the channel number registered to the channel map based on the channels displayed in the divided sections of the screen simultaneously.

If a key signal such as a direction key is inputted on the divided sections of the screen displaying the two channels and an identification key for selecting one of the channels is inputted (S160), the control part 110 controls the program of the selected channel to be displayed on the entire screen of the display part 109 (S170).

The audio signal received from the broadcasting program of the selected channel is outputted via a speaker.

In contrast, if the channel searching mode inputted by the user in S110 is a normal searching mode, the control part 110 receives and displays the channels in the order of the registration to the channel map, corresponding to the channel change signal (S180).

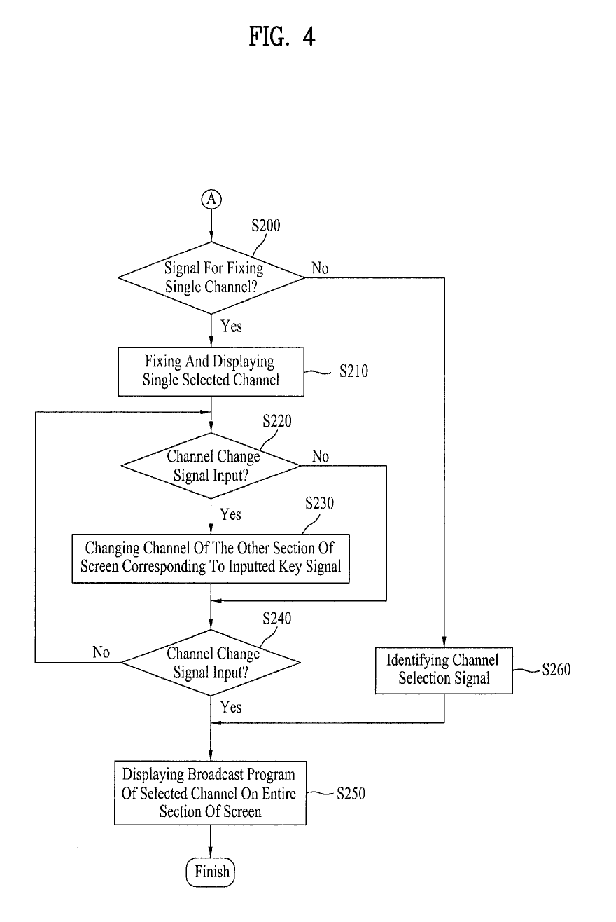

If a request signal of fixing one of the two channels displayed in one of the divided sections of the screen as shown in FIG. 4, not the channel change request signal of changing the two channels of the divided two sections simultaneously (S200), the control part 110 fixes the one channel selected by the direction key in the one of the divided sections (S210).

Hence, after identifying wither the user inputs the channel change signal (S220), if the channel change key signal is inputted, the channel of the other section which is not fixed is changed into another channel corresponding to the channel change key signal (S230).

At this time, the control part 110 outputs the audio received from the broadcasting program of the fixed channel displayed in the one of the divided sections by the user.

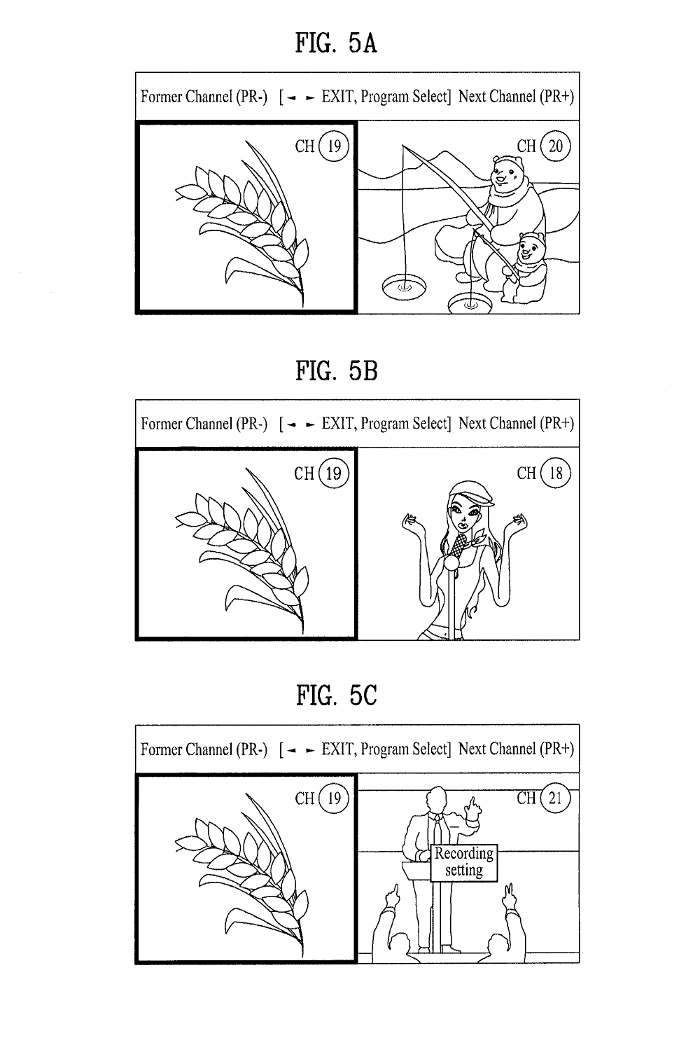

This process will be described more specifically in reference to FIGS. 5a to 5c.

As shown in FIG. 5a, broadcasting programs of ‘19 channel’ and ‘20 channel’ are received by the first and second tuners 101 and 102, respectively. If the direction key signal is inputted by the user and it is displayed that ‘19 channel’ is selected as shown in FIG. 5a, the control part 110 receives a screen section key input of channel fixing from the user and it fixes the broadcasting program of ‘19 channel’ on the selected section of the screen.

After that, the audio signal of the broadcasting program of ‘19 channel’ is outputted via the speaker.

Hence, if the user inputs a key signal of changing the channel into the former channel (PR−) which is the channel change key signal as shown in FIG. 5b, the control part 110 controls the other channel to be changed into ‘18 channel’ which is the former one of ‘19 channel’ and it provides a corresponding broadcasting program of ‘18 channel’, in the state of ‘19 channel’ being fixed on the section of the screen.

As shown in FIG. 5c, if the user inputs a key signal of changing the channel into the next one (PR+) which is the channel change key signal, the control part 110 controls the other channel, not fixed, to be changed into ‘21 channel’ which is the next one of the fixed 19 channel and it provides a corresponding broadcasting program of ‘21 channel’ on the other section of the screen, with ‘19 channel’ fixed on the section of the screen. If a channel change signal is inputted by the user's key input continuously, the channel is changed into ‘22 channel’, ‘23 channel’, ‘24 channel’, . . . in the order of the registration to the channel map and a corresponding broadcasting program is continuously displayed on the other section of the screen.

The information of the single channel is fixed in the one of the at least two divided sections of the screen and the information of the other channel is changed. While the two channels are provided on the screen, the key signal such as a direction key is inputted to select either of the two channels and then an identification key signal may be inputted (S240). If the identification key signal is inputted, the control part 110 controls the broadcasting program of the selected channel to be displayed on the entire section of the display part 109 (S250).

After that, the audio signal of the broadcasting program received from the selected channel is outputted via the speaker.

In the meantime, if the signal inputted by the user in S200 is not the channel fixing signal, the control part 110 identifies that the signal is a channel selection signal to display the corresponding broadcasting program of the selected channel on the entire section of the display part (S260).

Although not shown in the drawings, if either of the two channels displayed on the divided sections of the display part is selected via the direction key and a record set button, which is additionally provided in the remote control, is inputted, the control part 110 sets the broadcasting program of the selected channel to be recorded and stored in an external recording media such as a PVR.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention has an industrial applicability.

According to the present invention, a quick channel searching is achieved because information of two channels may be searched simultaneously on at least two divided sections of a screen with a single channel change input signal.

Furthermore, it is possible to compare and select channels because one of the channels is fixed and only the other one is changeable on the at least two divided sections of the screen.

1. A method of searching a channel for a broadcast receiver comprising:
receiving a channel searching request;
displaying broadcasting programs received from at least two different channels on at least two divided sections of a screen, respectively, according to the channel searching request;
detecting a channel change signal, in a state of displaying the channels on the divided sections of the screen, and simultaneously changing the channels into different channels in an order of a channel number registered to a channel map based on the at least two channels according to the detected channel change signal; and
displaying a broadcasting program of a selected channel on an entire section of the screen if a channel selection signal is inputted on the divided screen.

2. The method as claimed in claim 1, wherein an audio signal of broadcasting programs received from the two different channels according to the channel searching request is muted.

3. The method as claimed in claim 1, wherein an audio signal of the selected broadcasting program is outputted if the channel selection signal is inputted.

4. The method as claimed in claim 1, wherein a basis channel of the at least two different ones is one of a channel viewed at the present, a channel registered to the channel map for the first time and a channel selected according to a number key input.

5. The method as claimed in claim 1, wherein the channels displayed on the at least two divided sections of the screen are changeable according to a key input corresponding to a channel number.

6. The method as claimed in claim 1, wherein broadcasting programs of the channels displayed on the at least two divided sections of the screen is recordable.

7. The method as claimed in claim 1, wherein a quick channel searching mode is set according to the channel searching request.

8. The method as claimed in claim 1, wherein the number of either of the two different channels is 2N−1 and the number of the other is 2N.

9. The method as claimed in claim 1, wherein the channel map is formed based on one of a user's favorite channel, a channel number, a channel genre and a list of channels viewed before.

10. The method as claimed in claim 1, further comprising:
performing one of selection, edition and renewal of information on the registered channels of the channel map on an OSD menu.

11. A method of searching a channel for a broadcast receiver comprising:
receiving a channel searching request;
displaying broadcasting programs received from at least two different channels on at least two divided sections of a screen, respectively, according to the channel searching request;
fixing the broadcasting program received from the one of the channels displayed on the divided sections of the screen;
detecting a channel change signal in the state of the broadcasting program being fixed;
changing the channel displayed on the other section in an order of channel numbers registered to a channel map based on the fixed channel number according to the detected channel change signal; and
displaying a broadcasting program of a selected channel on an entire section of the screen if a channel selection signal is inputted on the divided screen.

12. The method as claimed in claim 11, wherein an audio signal of the broadcasting program received from the fixed single channel is outputted.

13. The method as claimed in claim 11, wherein the basic one of the at least two different channels is one of a channel viewed at the present, a channel registered to the channel map for the first time and a channel selected according to a number key input.

14. The method as claimed in claim 11, wherein the channel displayed on each of the at least two divided sections of the screen is changeable according to a corresponding number key input.

15. The method as claimed in claim 11, wherein the broadcasting program of the channel displayed on each of the divided sections of the screen is recordable.

16. The method as claimed in claim 11, wherein the channel displayed on the other section is a channel which is the former one or the next one of the fixed channel.

17. The method as claimed in claim 11, wherein the channel map is formed based on one of a user favorite channel, a channel number, a channel genre and a list of channels viewed before.

18. The method as claimed in claim 11, further comprising:
performing one of selection, editing and renewal of information on channels registered to the channel map on an OSD menu.

19. An apparatus of searching a channel for a broadcast receiver comprising:
an IR receiving part for receiving a channel searching request signal and a channel change signal;
a memory for storing a channel map to which channels are registered;
first and second tuners for receiving at least two different channels, respectively, according to the channel searching request;
a control part for controlling broadcasting programs of the channels received by the first and second tuners to be displayed on at least two divided sections of a screen, the control part controlling the channels displayed on the divided sections of the screen to be simultaneously changed into former or next ones in an order of a channel number registered to the channel map, respectively; and
a display part for displaying the broadcasting programs of the channels via the at least two divided sections of the screen, respectively, according to the channel searching request.

20. The apparatus as claimed in claim 19, wherein the control part controls the channel displayed on the other section of the screen to be changed in an order of a channel number registered to the channel map based on a fixed channel, if a signal is inputted to fix one of the channels displayed on the at least two divided sections of the screen.

21. The apparatus as claimed in claim 19, wherein the control part mutes an audio signal of the broadcasting program received from one of the channels displayed on the at least two divided sections of the screen, which is an object of a channel searching according to the channel change signal.

22. The apparatus as claimed in claim 19, wherein the control part outputs an audio signal of a broadcasting program received from a selected channel if a channel selection signal is inputted for the broadcasting program received from the single fixed channel displayed on one of the divided sections of the screen.

23. The apparatus as claimed in claim 19, wherein the first tuner receives a basic channel and the basic channel is one of a channel viewed at the present, a channel registered to the channel map stored in the memory for the first time and a channel selected according to a number key input.

24. The apparatus as claimed in claim 19, wherein the first and second tuners receive 2N−1 channel 2N channel which are changeable according to a number key input.

25. The apparatus as claimed in claim 19, wherein the memory stores the channel map formed based on one of a user favorite channel, a channel number, a channel genre and a list of channels viewed before.

26. The apparatus as claimed in claim 25, wherein one of selection, editing and renewal of information of the channels registered to the channel map stored in the memory is performed on an OSD menu.

27. The apparatus as claimed in claim 19, wherein the control part sets the broadcasting programs received from the channels displayed on the at least two sections of the screen to be recordable.
